(19) United States
(12) Patent Application Publication
(10) Pub. No.: US 2014/0281535 A1
(43) Pub. Date: Sep. 18, 2014

(54) Apparatus and Method for Preventing Information from Being Extracted from a Webpage

(71) Applicant: Munibondsoftware.com, LLC, Roslyn Heights, NY (US)

(72) Inventors: Robert Kane, Roslyn Heights, NY (US); Mark Maclntyre, Pleasanton, CA (US)

(73) Assignee: Munibonsoftware.com, LLC, Roslyn Heights, NY (US)

(21) Appl. No.: 14/170,734

(22) Filed: Feb. 3, 2014

Related U.S. Application Data
(60) Provisional application No. 61/788,250, filed on Mar. 15, 2013.

(51) Int. Cl. H04L 29/06

(52) U.S. Cl. CPC H04L 63/0428
USPC 713/168

(57) ABSTRACT

An apparatus and method that prevents unauthorized extraction of content on a webpage is provided. The apparatus includes a server that provides data representing at least one webpage via a communication network to at least one requesting user, the data including source code, the source code having at least one attribute with an associated attribute name value. A processor is coupled to the server, analyzes the source code and selectively encrypts the attribute name value for each of the at least one attribute. The server provides a modified source code including the encrypted attribute name value to the at least one requesting user, the modified source code being able to be properly rendered on a display of the at least one requesting user and prevent unauthorized extraction of content associated with the at least one web page.

### CROSS REFERENCE TO RELATED APPLICATIONS

This Nonprovisional US patent application claims priority from U.S. Provisional Patent Application Ser. No. 61/788,250 filed Robert Kane et al. on Mar. 15, 2013 and which is incorporated herein by reference, in its entirety.

### FIELD OF THE INVENTION

This invention concerns an apparatus and method for protecting information on the world wide web, and more specifically, for preventing content of a website from being extracted or otherwise harvested using encryption and other data obfuscation techniques.

### BACKGROUND OF THE INVENTION

The world wide web is a platform that provides content to a plurality of interconnected users. The content may be encoded as web pages that are located using unique web address. There are no restrictions on the type of content available for access by the users. Web pages are encoded in a markup language. The source code is typically freely accessible to any user accessing the page. Along those lines, the source code may also be accessible by automated computer programs. As the world wide web provides access to such a large and varying quantity of content, it has been common for third parties to attempt to access and harvest content from a respective web page and use the harvested content for their own purposes. This is particularly desirable to third parties when the web page dynamically provides a user accessing the webpage with data derived from a data source stored on the server hosting the web page. This process of accessing and harvesting content from web pages is known as web scraping and the third party seeking the data is known as a web scraper. Typically, a web scraper may employ automated search and harvesting algorithms to access various web pages and parse the data to determine which data is to be harvested for use by the third party. For example, in the instance where the web page dynamically generates a set of data based on user input, a web scraper may employ a web scrapping program or algorithm that seeks to locate the original source of data from which the dynamically generated user results were derived.

Web scraping algorithms, also known as web crawlers, sequentially and systematically access a plurality of different web pages by following the various links displayed on each of the web pages. Once the pages are accessed, the structure of the web page (e.g. source code) and any data selectively displayable to a user accessing the web page may be parsed and analyzed. In response to analyzing one of the web page's structure and content displayable thereby, the web scraping algorithm automatically copies or otherwise acquires certain content from the web page and stores the content for use by the third party who initiated the web scraping activity. Web scraping is a highly customizable process and allows the third party to write algorithms that are able to selectively scrape only the content from web pages that are useful to the third party for its particular purpose. It is therefore desirable for web site purveyors that have unique and commercially valuable content displayable on the world wide web to protect this data from unauthorized access and use by third parties. One example of a web scraping algorithm may include following the page structure to find the location of desired content. Another example of a web scraping algorithm may include specifically targeting attributes/values in the underlying source code of a web browser. However, there is a drawback associated with providing protection from web scraping algorithms. Specifically, current methods of protecting against web scraping algorithms may negatively impact the rendering of a web page on the display of a user accessing the webpage. Additionally, as web scraping algorithms use the underlying data structure of a web page to identify, locate and copy content to be scraped, these algorithms are scalable and attempts at defeating these algorithms could be readily overcome as the sophistication of web scraping programmers increases. A system according to invention principles addresses deficiencies of known systems.

### SUMMARY OF THE INVENTION

It is therefore an object of the present system protect the information associated with a particular website from unauthorized access and harvesting by a third party. In particular, it is an object of the present system to encrypt and obfuscate the underlying source code of a particular web page/web site such that the obfuscated source code confuses or otherwise prevents a third party using a web scraping algorithm from accessing any content associated with the web page. It may be a further object of the present system to provide a system which selectively detects the activity of a web scraping algorithm and updates the protection applied to the website in response to the detection.

In one embodiment, an apparatus and method that prevents unauthorized extraction of content on a webpage is provided. The apparatus includes a server that provides data representing at least one webpage via a communication network to at least one requesting user, the data including source code, the source code having at least one attribute with an associated attribute name value. A processor is coupled to the server, analyzes the source code and selectively encrypts the attribute name value for each of the at least one attribute. The server provides a modified source code including the encrypted attribute name value to the at least one requesting user, the modified source code being able to be properly rendered on a display of the at least one requesting user and prevent unauthorized extraction of content associated with the at least one web page.

In another embodiment, the processor compares the associated attribute name value in the source code to a set of associated attribute name values stored in a configuration file and encrypts all attribute name values in the source code having a corresponding attribute and associated attribute name value in the configuration file.

In a further embodiment, the processor analyzes at least one externally linked file contained in the source code to locate associated attribute name value and encrypt the associated attribute name value within the at least one externally linked file thereby maintaining a reference between the at least one externally linked file and the source code.

In another embodiment, the processor replaces a URL identifying the at least one externally linked file with a modified URL including a token, the token enables the server to decrypt the externally linked file prior to providing content associated with the at least one externally linked file to the requesting user.

In another embodiment, the processor automatically replaces each instance of the associated attribute name value in the source code with a corresponding encrypted attribute name value and the encryption of the associated attribute name values by the processor prevents unauthorized extraction of content by a automated computer program.

In a further embodiment, the processor uses an encryption key and salt value to encrypt the attribute name values and the processor periodically changes an encryption key and salt value used to encrypt the associated attribute name value and automatically re-encrypts the associated attribute name value using the changed encryption key

A further embodiment includes a scanning processor that selectively scans source code of the at least one web page and automatically generates a set of attributes and associated attribute name values derived from the scanned source code for inclusion a configuration file. The scanning processor automatically generates the configuration file including the set of attributes and associated attribute name values determined in the scan of the source code.

In a further embodiment, the processor periodically analyzes an activity log of the server to detect whether an occurrence of an activity associated with unauthorized extraction of content was attempted and re-encrypts the associated attribute name value in response to detecting the occurrence.

In another embodiment, the processor selectively inserts data in a section of source code of the at least one web page thereby obfuscating the source code and preventing unauthorized extraction of content associated with the at least one web page.

### BRIEF DESCRIPTION OF THE DRAWINGS

FIG. 1 is a block diagram of the system according to invention principles;

FIG. 2 is an example of raw source code processed by the system according to invention principles;

FIGS. 3A & 3B are examples of modified source code generated by the system according to invention principles;

FIG. 4 is flow diagram detailing an exemplary operation of the system according to invention principles;

FIGS. 5A & 5B are timelines detailing operation of the system according to invention principles;

FIG. 6 is an exemplary block diagram listing hardware included in the system according to invention principles; and

FIG. 7 is a flow diagram detailing an exemplary operation of the system according to invention principles.

### DETAILED DESCRIPTION

An apparatus and method for preventing information on a web site from being extracted is provided. The apparatus and method is embodied in a system that advantageously and automatically prevents unauthorized access and harvesting of content associated with a particular website. As used herein, the term content may mean any type of data hosted or accessible by a web site that may be selectively provided for display to a user. The content may be static and unchanging or may be dynamically generated by one or more scripts executed by the web site. Content may include a set of data, for example, data stored in a database, or a subset of data derived from the set of data stored in the database. Additionally, content may be present at any location on any page displayable to a user using a browsing application on a computing device. The system advantageously disables algorithms that may be used to access and harvest web site content. These algorithms may represent a series or set of instructions executable by a computing device that automate the process of accessing website content and harvesting the accessed content (e.g. web scraping) on behalf of a party other than the owner/operator of the particular website. The system advantageously disables these algorithms by encrypting and otherwise obfuscating values in the source code (e.g. including but not limited to raw HTML, CSS, JavaScript, XML, etc) that sets forth the parameters for rendering the webpage to a user. By encrypting or otherwise obfuscating values in the source code, the scraping algorithm will be prevented from accessing any content. Alternatively, even if the scraping algorithm was able to locate a portion of the webpage where content should be, the algorithm would be confused and any data harvested thereby would not be the data originally sought by the scraping algorithm. Rather, the system advantageously provides scraping algorithms with nonsensical content that would be unusable by the third party who employed the scraping algorithm. The system further advantageously maintains the content on a webpage in a protected state by periodically and automatically regenerating new encryption associated with the underlying source code at predetermined intervals. This automatic regeneration of the encryption may be referred to as “page shaking” and advantageously minimizes the ability of a scraping algorithm to “learn” the location of the content on the page using the encrypted source code parsed during a prior instance of web scraping. The system advantageously identifies a path at which content is located and modifies this path by making it invisible and not otherwise accessible by a scraping algorithm.

The system advantageously analyzes the source code of a web page and automatically identifies at least one attribute on the page that is associated with content to be protected. An attribute may include any item on a web page that provides information identifying how the particular web page is displayed to an accessing user. An attribute may also provide information to a web browser identifying a location at which content is stored. An attribute may also provide information identifying an executable script or application that provides content to a user who is accessing the web page. In another embodiment, an owner or purveyor of a web page may selectively supply a predetermined list of attributes associated with content that they desire to be protected. Attributes may provide additional elements that are used to structure a webpage to be rendered and may operate as name value pairs. Exemplary attributes may include any of (a) ID=; (b) Class=; (c) style=; (d) title=; (e) tabindex=; (f) contextmenu=; (g) accesskey=; (h) dir=; (i) draggable=; (j) dropzone=; (k) lang=; (l) spellcheck=; and (m) translate=. These attributes are described for purposes of example only and the present system may advantageously encrypt any attribute name value associated with any global HTML attribute. Each attribute on a web page has an associated attribute name which represents a respective HTML element and is not displayed to a user who requests the web page. The system advantageously encrypts the attribute value names throughout the source code of the webpage

A configuration file is associated with the web page and includes the at least one attribute and the attribute name value associated with the attribute. The configuration file selectively provides the attribute name value for encryption thereof. In one embodiment, the configuration file includes both the global HTML attribute and its associated attribute name value. This may allow for both the attribute and the attribute name value to be encrypted prior to being provided to a user requesting the webpage data.

The configuration file may advantageously maps attribute name values to be encrypted with encrypted attribute values. These encrypted attribute values are selectively provided to a web server that serves the web page to users. Prior to providing the source code comprising raw HMTL to the users, the web server uses the configuration file to automatically parse and replace the at least one attribute name value with an encrypted attribute name value. The web server advantageously replaces every instance of the attribute name value in the source code with the encrypted attribute name value thereby enabling the end user to properly render the web page in its intended form. This provides transparent protection of the content of the web page without negatively impacting the experience of the user attempting to access the web page. The configuration file may include HTML attribute name values that define the structure and formatting of content being displayed to the user.

Additionally, the configuration file may include attribute name values in externally linked data files (e.g. CSS and JavaScript data files). In one embodiment, the configuration file may include a first attribute which may be “class” having an associated class name value associated therewith and second attribute being “id” having an associated id name value. The class value and id value may be in the raw HTML source code of the web page. Alternatively, the class value and id value may be in an externally linked data file. By automatically encrypting one of the class name value and the id name value associated with content, the browser charged with rendering the web page will be able to render all content data (including any assigned styles defined by the attribute value) in the intended manner.

In another embodiment, the system may automatically scan the source code of the webpage data stored at the web server to identify attributes and associated attribute name values having content associated therewith. Upon completion of the scan, the system may generate a configuration file that includes a set of candidate attribute names values for encryption. Alternatively, the system may generate the configuration to include both attribute and associated attribute name values. In a further embodiment, the system may modify a current configuration file to include attribute and/or attribute name values not previously contained in the configuration file.

In another embodiment, the configuration file may include a set of predetermined obfuscation values that are dynamically inserted at predetermined locations within the source code in response to user request for the web page. In one embodiment, obfuscation values may inserted into the source code of the webpage at least one of before and after predetermined HTML elements and/or attributes. The predetermined HTML elements may be listed in the configuration file enabling the system to parse the HTML source code of a webpage and, upon locating any HTML elements that correspond to the set of predetermined HTML elements, automatically insert obfuscation values within the source code surrounding these elements. For example, if a predetermined HTML element is “<table>”, the system may automatically insert obfuscation values surrounding the element thereby obfuscating the underlying HTML element and any associated content from being accessed by a web scraping algorithm. In another embodiment, the system may automatically parse the source code of the webpage and specifically target html elements within the source code which are identified by specific class and/or id attribute values. Once located, the system may target these HTML elements can be targeted for injection of predetermine obfuscation values. For example, the system may operate as an HTML parser and, as it parses through the page, the system selectively locates html elements identified in the configuration file and automatically injects the configured obfuscation values either before, after, or both before and after the target element. The obfuscation values selectively inserted by the system may be uniform throughout the webpage. Alternatively, the obfuscation values may be configured to be different depending on the HTML element that is being replaced. This may advantageously vary the number and type of obfuscation values inserted by the system.

FIG. 1 is a block diagram illustrating the architecture of the system 10 for preventing extraction of data from webpage according to invention principles. The system 10 operates in accordance with well known principles of web architecture used in providing users on the internet with access to a variety of web pages that provide content to the users. The following description will be provided with respect a web page that is hosted on a particular server and which is selectively accessible by at least one user at a unique web address. This description is provided for purposes of example only and the system 10 according to invention principles may be implemented on any number of web pages hosted by one or more web servers. Moreover, the present system 10 is scalable so that it may be operated simultaneously on different web pages at any given time.

As shown in FIG. 1, a web server 20 hosts at least one web page that is selectively accessible by at least one client 22 when the client 22 enters the web address associated with the webpage stored on the web server 20. The client 22 may be any computing device that is able to selectively connect to a wide area network or local area network. The client 22 may include any of (a) a personal computer; (b) a tablet computing device; and (c) a smartphone. The description of type of client devices is provided for purpose of example only and the client may be any machine or computing device that may selectively access a communication network to request and retrieve data representing a webpage. Despite only a single client machine 22 being shown in FIG. 1, it is well understood that a plurality of different client machines at different locations may selectively access the webpage stored on web server 20 simultaneously at any given time. The number of client machines 22 able to access the particular web page is a function of how many simultaneous connections the web server 20 is able to handle at any given time.

The web server 20 stores all data associated with the webpage. This includes formatting data that identifies and controls the structure and format of the webpage and content data which represents the data displayed to the user requesting the webpage. The formatting data is used by a browsing application to control how the web page is rendered to the user requesting the web page. The formatting data may include a plurality of attributes that describe the structure of the web page including the style, type and location of certain content data on the webpage. Each attribute has an attribute name associated therewith that describes certain content data. Generally, the formatting data is not visible to the user who requests the web page without explicitly requesting to view the source code of the web page. Web pages are generally encoded using hypertext markup language (HTML). HTML structure and operation is well known to persons skilled in the art of web development and programming and need not further be described.

The web server 20 further includes the system 10 according to invention principles. The system 10 includes a processing module 12 (e.g. processor) that selectively controls the operation of the system 10 in the manner discussed below. As shown herein, the processing module 12 is identified as a “Server Module” and the web server 20 is identified as a “Web Server”. In one embodiment, the web server may execute Apache Web Server software and the processing module may be an Apache Server Module. However, this is merely exemplary and provides one type of web server that is able to host a website comprised of at least one webpage. The web server may execute any type of web serving software and the processing module 12 may be encoded in any language able to interact with the web server to which the processing module is connected. The system further includes a configuration file 14 stored on a data storage medium and a memory 16 that is selectively accessible by the processing module 12 for use in providing data representing a web page stored on the web server 20 to the client 22. The configuration file 14 includes data representing attribute name values associated with attributes in the source code for the webpage. In another embodiment, the configuration file 14 may include data representing attributes and associated attribute name values. The associated attribute name values contained in the configuration file 14 are to be dynamically encrypted prior to being provided to a client 22 requesting web page data from the web server 20.

The configuration file 14 may be populated using a set of attribute name values present in the source code of the webpage stored at the web server 20. In one embodiment, the attribute name values may be provided by the owner of the webpage based on their individual knowledge of the content provided by the webpage and the location of the content within the webpage. In another embodiment, the configuration file 14 may be dynamically generated by the processing module 12. In this embodiment, the processing module 12 may selectively parse the source code of the webpage stored on the web server 20 and identify a plurality attribute name values associated with various attributes present in the source code that may be candidates for encryption. Parsing the source code of a web page may result in the generation of data representing a scraping assessment vulnerability index (SAVI) for the particular webpage. The SAVI may describe and define a success level that scraping algorithm may have when run on the webpage. The processing module 12 may generate a recommendation report including all identified attribute name values and provide the report to the owner of the webpage enabling selection of a set of identified attribute name values to be included in the configuration file 14. In another embodiment, the configuration file 14 may be automatically modified in response to detection by the web server 20 or processing module 12 of access by a web scraping algorithm. In this instance, the processing module 12 may selectively determine the content accessed by the suspected web scraping algorithm and automatically add the attribute name values to the configuration file 14 such that the modified webpage data 5 will include these newly identified encrypted attribute name values.

In another embodiment, the configuration file 14 may be populated using a set of attributes and/or attribute name values present in the source code of the webpage stored at the web server 20. In one embodiment, the attributes and attribute name values may be provided by the owner of the webpage based on their individual knowledge of the content provided by the webpage and the location of the content within the webpage. In another embodiment, the configuration file 14 may be dynamically generated by the processing module 12. In this embodiment, the processing module 12 may selectively parse the source code of the webpage stored on the web server 20 and identify a plurality of attributes and attribute name values present in the source code that may be candidates for encryption. Parsing the source code of a web page may result in the generation of data representing a scraping assessment vulnerability index (SAVI) for the particular webpage. The SAVI may describe and define a success level that scraping algorithm may have when run on the webpage. The processing module 12 may generate a recommendation report including all identified attributes and attribute name values and provide the report to the owner of the webpage enabling selection of a set of identified attributes and attribute name values to be included in the configuration file 14. In another embodiment, the configuration file 14 may be automatically modified in response to detection by the web server 20 or processing module 12 of access by a web scraping algorithm. In this instance, the processing module 12 may selectively determine the content accessed by the suspected web scraping algorithm and automatically add the attribute and attribute name values to the configuration file 14 such that the modified webpage data 5 will include these newly identified encrypted attribute name values. In general operation, the client 22 issues a request 1 across a communications network (e.g. internet, intranet, etc) to access a webpage stored at web server 20. The request 1 may include an initial request to load the webpage. Alternatively, the request 1 may represent a request for additional content provided by the webpage after the initial loading of the webpage on the client machine 22. The request 1 is received by the web server 20 and the web server 20 uses the data contained in the request 1 to provide raw webpage data 2 (e.g. source code) representing the requested content to the processing module 12. The processing module 12 uses data in the configuration file 14 to parse the raw webpage data 20 to identify places in the source code of the raw webpage data 20 that include the attribute and associated attribute name value. The processing module 12 encrypts 3 the attribute name value using strong data security methods. The processing module encrypts each attribute name value using an encryption key and a particular cryptographic salt value. The cryptographic salt value may be random data used as an additional input to a one-way encryption function. At any given time, the processing module uses the same encryption key and cryptographic salt value for encrypting each attribute name value in the configuration file that is also in the source code of the raw webpage data 20. The processing module stores the encryption key value and its associated cryptographic salt value in memory 16. The processing module 12 uses one-way encryption by creating a HASH value for the given encryption key and salt value. The processing module 12 further replaces all instances in the raw webpage data 20 of the name value of the attribute with the encrypted name value 4 stored in memory 18. As used herein, the encrypted name value includes reference to the encryption key used and the cryptographic salt value associated therewith. By replacing the attribute name values listed in the configuration file 14 with the encrypted attribute name values stored in memory 16, the processing module 12 generates modified webpage data 5. Thus, these values are not provided to and decrypted by the browsing application at the client machine 22. Rather, they remain encrypted at all times and the processing module 12 provides the correct content data associated therewith when requested by the browser application. In addition to encrypting the attribute name values in the HTML source code, the processing module 12 will parse all externally linked files (e.g. CSS, Javascript, etc) for the attribute name values and replace those attribute name values with the encrypted attribute name values. This allows any and all styling and formatting associated with the content data referenced by the encrypted attribute name values to be rendered properly by the browsing application at the client machine 22. This is performed by attaching a token to the URL of linked external files. The token includes a string that references the encryption key and cryptographic salt value used in encrypting the encrypted attribute name values in the externally linked file. When the browser requests the externally linked file, the processing module 12 decrypts the token which is used to ensure that the linked resources in the external files are synchronized (e.g. includes the same HASH value) with the underlying HTML source code. For example, a token of an externally linked file is decrypted by the processing module. The resulting string in the token represents the salt value and encryption key used to encrypt the attribute name values in the source code of the parent HTML file. This salt value is then used to encrypt the attribute values in the externally linked files so the encrypted values will be the same between the HTML file and all externally linked files. Thus, an attribute name value ‘table_data’ in the parent HTML page will be encrypted with salt value of “salt1”. The token ensures that the attribute value ‘table_data’ defined in an external CSS style sheet will also be encrypted with a salt value of “salt1”.

This advantageously enables the browser to properly render any assigned styles defined by the attribute name values. The modified webpage data 5 including the encrypted attribute name values is then provided to the client machine 22. This advantageously provides transparent, one way encryption that does not negatively impact the rendering of the requested webpage by the client 22 as all encrypted attribute name values are uniformly replaced throughout the entire source code enabling the browser application to properly maintain the reference to the attribute and attribute value throughout.

The processing module 12 also automatically regenerates at least one of (a) the encryption key used to encrypt the attribute name values and (b) the salt value used when encrypting the attribute name values identified in the configuration file 14. This automatic regeneration of the encryption key and/or salt value may occur periodically or at a predetermined time intervals. For example, the predetermined time intervals at which the processing module 12 may regenerate the encryption key including, but not limited to, one of (a) daily; (b) weekly; and (c) hourly. These intervals are described for purposes of example only and the processing module 12 may regenerate the encryption key and/or salt value at any interval or upon the occurrence of a specific action, e.g. when a new user attempts to access the webpage. Alternatively, the processing module 12 may regenerate the encryption key and/or salt value in response to user command.

In a further embodiment, the processing module 12 may regenerate the encryption key and/or salt value automatically in response to an event detected by the web server 20. In operation, the processing module 12 may use a monitoring module which parses an activity log generated by the web server 20 to identify patterns that may be representative of both authorized and unauthorized scraping activity. For example, if the web server 20 detects or perceives that the request for accessing the webpage was generated by a web scraping algorithm and not a bona fide client 22, the processing module 12 may automatically regenerate the encryption key and/or salt value in a process termed “page shaking”. In this embodiment, a web scraping algorithm may obtain the modified webpage including a set of encrypted attribute name values but any further request for content associated with the attribute name values would be prevented because the algorithm would seek to access the content using old outdated encryption references and not the newly encrypted attribute name values that were generated using the regenerated encryption key and/or salt value.

In another embodiment, the processing module 12 may generate a second encrypted attribute name value using at least one of a second different encryption key and second different salt value. The processing module 12 may utilize the second encrypted attribute name values in generating a second set of modified webpage data that may be provided to a client. The second encrypted attribute name value may be inoperable such that access to the content associated with the attribute name value is prevented. This second modified webpage data including the second encrypted attribute value names may be selectively provided to a user who is determined by one of the web server 20 and processing module 12 to be attempting an unauthorized extraction of data from the webpage. By automatically providing a second different set of encrypted attribute name values to a suspected web scraping algorithm further improves the systems 10 ability to continually defend against these unauthorized extraction attempts because persons charged with generating the web scraping algorithm will seek to adapt the crawling operation using a falsely generated encryption value. This will result in reducing the speed at which these web scraping algorithms are able to learn the true underlying structure of the web page and the content data provided by the webpage.

In addition to encryption of attribute name values as discussed above, the processing module 12 may selectively obfuscate the webpage structure when generating the modified web page data 5 provided to the client. The processing module 12 may obfuscate webpage data by inserting additional code within the source code of the webpage. The additional code is structural in nature but will have no visible effect when rendered at the client machine. Moreover, the obfuscation of webpage data occurs dynamically and is applied as the webpage is being processed. That is to say, the insertion points are not predetermined and rather are associated with particular attributes and attribute name values that may or may not be included in the configuration file 14. Using the structure of the content data sought to be protected, the processing module 12 will analyze this structure and replicate ghost clones of the structure in which the content is being displayed.

FIG. 2 represents an exemplary piece of source code representing raw webpage data 20 stored at web server 20. The source code defines the structure and content of a web page able to be requested by a client 22. This segment of HTML source code 200 includes a first attribute 202 having a first attribute name value 204 associated therewith. As shown herein, the first attribute 202 is “table id” and the associated attribute name value 204 is “table_data”. This segment of HTML source code 200 further includes a second attribute 206 having a second attribute name 208 associated therewith. As shown herein, the second attribute 206 is “class” and the second associated attribute name value 208 is “ddisplay”. In this example, the configuration file may include at least one of (a) the first attribute 202; (b) the first associated name value 20; (c) the second attribute 206; and (d) second associated name value 208 indicating that the content associated with these attributes and attribute name values should be protected from unauthorized extraction by a web scraping algorithm. These attributes and name values may have been provided by the website operator or may have been added after the processing module identified these attributes and name values as being susceptible to scraping.

In response to a request for this webpage, the source code 200 is provided to the processing module 12 (FIG. 1) which parses the source code 200 for attributes and/or attribute name values listed in the configuration file. Upon identifying that attributes and attribute name values in the source code 200 match attributes and attribute name values in the configuration file, the processing module encrypts the attribute name values using the encryption key and/or salt value and generates modified source code 300 as shown in FIG. 3A.

The modified source code 300A in FIG. 3A shows the first attribute 202 having a first encrypted attribute name value 302 associated therewith. Additionally, the second attribute name value 206 has a second encrypted name value 304 associated therewith. In another embodiment, the processing module may generate the modified source code shown in FIG. 3B. As shown in FIG. 3B, the modified source code 300B includes obfuscation data 310 contained therein. The processing module inserted obfuscation data 310 which modifies the underlying source code structure but does not affect the rendering of the webpage on the client machine. The inserted code will be hidden from the user's view using common CSS techniques to hide content. For example, one technique is to add to the element the attribute ‘style=“display:hidden”. This technique is described for purposes of example only and any technique able to hide content contained in HTML source code from a user's view may be used.

FIG. 4 is a flow diagram detailing how tokens associated with an externally linked file are processed to maintain all attribute name value references in the externally linked file with those in the parent HTML file. This process enables the webpage to be properly rendered by a browsing application. An exemplary URL 400 that may be present in the source code of the webpage is provided. The URL 400 is associated with an externally linked file and includes a token 402. The token is a unique encrypted value that enables the web server and processing module to know which encryption key and salt value was used in encrypting the attribute name values contained in the externally linked file. Thus, the token value includes a data value representative of a encryption key and/or salt value used to encrypt attribute name values at the present time. As encryption keys and/or salt values are periodically changed, the token value will change accordingly to provide the server with the proper reference for decrypting the attribute name values within the externally linked file.

In operation, once the browser application requests data associated with the URL 400 (either automatically in the background or in response to user selection of a hyperlink), the token value is provided to the server module at block 404. The server module parses the token value to decrypt and obtain the encryption key and/or salt value used to create the token in block 406. The server module processes the externally linked file properly because the server module knows which encryption key and salt value was used to encrypt the attribute name values in the external file. The external file is able to provide the correct processing to the content associated with the encrypted attribute name values in block 408. Thereafter, the server module applies the correct style and/or formatting contained in the external file and which is associated with the encrypted attribute name values in the parent HTML. Thus, all references are properly maintained throughout all levels of source code to ensure that the user experience is not diminished while preventing any web scraping algorithm from accessing the content associated therewith because the encryption renders the attribute and/or attribute name values irrelevant or unreadable.

FIG. 5A represents the timeline and steps associated with a request by a user to access a webpage. The x-axis represents time in seconds and the area above x-axis represents client-side activity while the area below the x-axis represents server-side activity. A client may issue a request 502 for a webpage at time t=0 by entering a URL associated with the webpage. This request is communicated across a communication network and received by the web server that hosts the requested webpage. The web server parses the request to identify the scope of the request and determine what raw HTML data is needed to satisfy the request. The raw HTML data is provided to the processing module in order to modify the raw HTML data to prevent the unauthorized extraction of the underlying content provided by the raw HTML. The processing module parses raw HTML data and compares attribute and attribute name values in the raw HTML data with attribute and attribute name values listed in a configuration file. The processing module automatically encrypts any attribute name values in the raw HTML data that match those in the configuration file. Each instance of an attribute name values in the raw HTML is replaced with a corresponding encrypted attribute name value. Additionally, the processing module parses any externally linked files (CSS files and/or JavaScript files) identified within the raw HTML and replaces the URLs identifying the externally linked files with modified URLs including a token. The token indicates that the externally linked file includes name value attributes from the raw HTML that were replaced and enables the system to maintain proper referencing between the raw HTML and the externally linked file in order to ensure that the webpage accessed by the user will render properly in as if the user was accessing the webpage via the raw HTML.

Thus, the processing module generates modified HTML data that includes the encrypted name attribute values and modified URLs for externally linked files that also include the name attribute values. This modified HTML data is provided at 504 to the requesting client. At 506, additional call back requests are issued by the client to load certain CSS and Java files. These call back requests utilize the modified URLs including the token to access the underlying data associated therewith. Once the data associated with the call back requests have been acquired, the webpage is rendered by the browser at the client machine at 508.

FIG. 5B represents a similar timeline including similar steps as described above with respect to FIG. 5A. This timeline includes a further activity representing the page shaking that may be employed by the present system. The activities associated with request 502 and providing modified HTML data in 504 are the same as those described in FIG. 5A and need not be repeated. The additional page shaking feature 510 represents a regeneration of one of a configuration file and a new encryption key and/or salt value to be used in encrypting the attribute name values listed in the configuration file. In response to regenerating the configuration file, the attribute name values are re-encrypted using the new encryption key and/or salt value and are different values than those that were provided in the modified HTML during 504. The processing module automatically generates new modified HTML data using the raw HTML data and the new configuration file. However, the client attempting to engage in call back requests to load the external files at 506 will be unable to do so because those callback requests will be utilizing the previous encrypted attribute name values and tokens that are no longer valid. The client will have refresh the page request to be provided with the new modified HTML using the encryption key in the regenerated configuration file to access the externally linked files.

FIG. 6 is a block diagram showing exemplary hardware used in implementing the system for protecting the content on webpages from unauthorized extraction. The system is implemented by an apparatus 600. The apparatus 600 may be any type of dedicated computing hardware programmed to execute a set of instructions that perform the functions discussed throughout the description of FIGS. 1-7. The apparatus 600 includes a processor 602. The processor 602 may operate in a similar manner as discussed above with respect to the processing module 12 in FIG. 1. Thus, these features will not be repeated in the detail discussed above. The processor 602 provides automatic protection for content on a webpage against unauthorized access, extraction and use thereof. The protection provided by the processor 602 is natively applied to the website and need not be triggered by any activity or interaction with the webpage. As such, the processor 602 automatically modifies the source code of a website to include at least one of encrypted attribute name values and provides the modified source code in response to any request by any user. This advantageously prevents any user from viewing or knowing the various html attribute name values thereby preventing any automatic access and extraction of the content associated with those attribute name values.

The apparatus further includes a configuration file 604 that is selectively accessible by the processor 602. The configuration file 604 includes data representing attribute name value that are to be encrypted prior to providing webpage data to a requesting user. The configuration file 604 may also include data representing various HTML attributes which may also be encrypted. The configuration file 604 may be pre-populated with a set of attribute name values known to be associated with content which might be scraped by an automated scraping algorithm.

An encryption processor 605 is coupled to the processor 602 for selectively generating an encryption key for use in encrypting the attribute name values in the source code which match attribute name values in the configuration file 614. The encryption processor 605 may also generate a secondary encryption metric for use in encrypting the attribute name values. In one embodiment, the secondary encryption metric is a salt value. The use of a salt value is describe for purposes of example only and any metric able to supplement a one-way encryption scheme may be used as the secondary encryption metric. The encryption processor 605 may periodically regenerate the encryption key and/or the secondary encryption metric that will be applied when encrypting the attribute name values in the source code. Thus, at different points in time, the same source code may have attribute name values that are encrypted using different encryption keys and/or secondary encryption metrics. Additionally, the encryption processor 605 may automatically regenerate the encryption key and/or the secondary encryption metric in response to the detection of an event by the processor 602. Examples of events include, but are not limited to, (a) a unique request received by the server 610 for the webpage data; (b) determination by the processor 602 that a request for webpage data was issued by an automated web scraping algorithm; and (c) at predetermined time intervals.

The apparatus 600 may interface with a server 610 that stores webpage data and provides webpage data to a requesting user 614 via a communication network 612. The communication network 612 may be any type of network including a local area network, wireless network, cellular network and any other type of wide area network such as the internet. A single user 614 is shown herein as an example only and any number of users may access the webpage data stored on server 610 via the communication network 612. The server 610 may perform any and all functions associated with a web server.

The apparatus 600 may further include a scanning processor 606 coupled the processor 602. The scanning processor 606 may selectively scan the source code associated with a webpage stored at the server 610 to identify at least one attribute name value having content associated therewith. The scanning processor 606 may generate a set of recommendations of attribute name values that should be encrypted based on the type of content they are associated with and their perceived susceptibility of being scraped by a web scraping algorithm. In another embodiment, the scanning processor 606 may generate configuration file 614 in response to scanning of the source code and identifying at least one attribute name value to be encrypted. In another embodiment, the scanning processor 606 may periodically scan the source code of the webpage data stored at server 610 to identify any changes in the source code and automatically update the configuration file 614 with any newly added attribute name values found in the source code.

The operation of the apparatus 600 will be discussed with respect to the flow diagram of FIG. 7. At block 702, an incoming request for webpage data is received by the server 610. The request is processed by the server 610 in block 704. Block 704 includes providing the webpage to the processor 602 which analyzes the webpage. The configuration file 604 is used in block 705 by the processor 602 to analyze the webpage to identify attribute name values to be encrypted. Encryption information (e.g. encryption key, salts, etc) are provided in block 706 for encrypting the attribute name values that are listed in the configuration file and found to be present in the source code of the webpage.

The processor 602 uses the encryption information provided in block 706 to encrypt the attribute name values in block 708. This also includes encrypting any instance of the attribute name value throughout the source code. Additionally, the attribute name values contained in any externally linked files (e.g. CSS, JavaScript, XML, etc) are also replaced with the encrypted attribute name values. In the instance that an externally linked file includes an encrypted attribute name value, the encryption processor 605 generates a token having a token value that represents the encryption key and secondary encryption metric used to encrypt the attribute name value within the externally linked file.

The processor 602 generates, in block 710, modified source code including the encrypted attribute name values and modified URL links with tokens for any externally linked files that include encrypted attribute name values. This modified source code is output via the communication network 612 and received by the user 614.

At block 712, there is a query as to whether the resource being accessed by the requesting user 614 is an externally linked resource. If the answer to the query in block 712 is negative, then the browser at the requesting user renders the modified webpage data at block 714. Because the encrypted attribute name values are carried throughout the source code and externally linked files, the browser at the requesting user machine 614 can properly render the webpage as if it was using the native, non-modified source code. Alternatively, if the resource being accessed by the requesting user is an externally linked resource, the browser requests access to the externally linked file(s) in block 716. The request for the externally linked file is provided to the web server 610 for processing thereof to obtain the data associated with the externally linked file and provide that data to the requesting user. The process by which these externally linked files are accessed is discussed above in FIG. 4 which explains the encryption scheme and access to the content in the externally linked file. Once properly accessed, the operation continues and renders all data associated with the requested webpage.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus that prevents unauthorized extraction of content on a webpage, the apparatus comprising:
a server that provides data representing at least one webpage via a communication network to at least one requesting user, the data including source code, the source code having at least one attribute with an associated attribute name value;
a processor, coupled to the server, that
analyzes the source code, and
selectively encrypts the attribute name value for each of the at least one attribute; wherein said server provides a modified source code including the encrypted attribute name value to the at least one requesting user, the modified source code being able to be properly rendered on a display of the at least one requesting user and prevent unauthorized extraction of content associated with the at least one web page.

2. The apparatus according to claim 1, wherein
said processor compares the associated attribute name value in the source code to a set of associated attribute name values stored in a configuration file and encrypts all attribute name values in the source code having a corresponding attribute and associated attribute name value in the configuration file.

3. The apparatus according to claim 1, wherein
said processor analyzes at least one externally linked file contained in the source code to locate associated attribute name value and encrypt the associated attribute name value within the at least one externally linked file thereby maintaining a reference between the at least one externally linked file and the source code.

4. The apparatus according to claim 1, wherein
said processor replaces a URL identifying the at least one externally linked file with a modified URL including a token, the token enables the server to decrypt the externally linked file prior to providing content associated with the at least one externally linked file to the requesting user.

5. The apparatus according to claim 1, wherein
the processor automatically replaces each instance of the associated attribute name value in the source code with a corresponding encrypted attribute name value.

6. The apparatus according to claim 1, wherein
the encryption of the associated attribute name values by the processor prevents unauthorized extraction of content by a automated computer program.

7. The apparatus according to claim 1, wherein
the processor uses an encryption key and salt value to encrypt the attribute name values.

8. The apparatus according to claim 7, wherein
the processor periodically changes an encryption key and salt value used to encrypt the associated attribute name value and automatically re-encrypts the associated attribute name value using the changed encryption key

9. The apparatus according to claim 1, further comprising
a scanning processor that selectively scans source code of the at least one web page and automatically generates a set of attributes and associated attribute name values derived from the scanned source code for inclusion a configuration file.

10. The apparatus according to claim 9, wherein
the scanning processor automatically generates the configuration file including the set of attributes and associated attribute name values determined in the scan of the source code.

11. The apparatus according to claim 1, wherein
the processor periodically analyzes an activity log of the server to detect whether an occurrence of an activity associated with unauthorized extraction of content was attempted and re-encrypts the associated attribute name value in response to detecting the occurrence.

12. The apparatus according to claim 1, wherein
said processor selectively inserts data in a section of source code of the at least one web page thereby obfuscating the source code and preventing unauthorized extraction of content associated with the at least one web page.

13. A method for preventing unauthorized extraction of content on a webpage comprising the activities of:
providing data representing at least one webpage stored on a server via a communication network to at least one requesting user, the data including source code, the source code having at least one attribute with an associated attribute name value;
analyzing the source code by a processor;
selectively encrypting the attribute name value for each of the at least one attribute; and
providing, by the server, a modified source code including the encrypted attribute name value to the at least one requesting user, the modified source code being able to be properly rendered on a display of the at least one requesting user and prevent unauthorized extraction of content associated with the at least one web page.

14. The method according to claim 13, further comprising
comparing, by the processor, the at least one attribute and associated attribute name value in the source code to a set of attributes and associated attribute name values stored in a configuration file; and
encrypting, by the processor, all attribute name values in the source code having a corresponding attribute and associated attribute name value in the configuration file.

15. The method according to claim 13, further comprising
analyzing, by the processor, at least one externally linked file contained in the source code to locate said at least one attribute and associated attribute name value; and
encrypting, by the processor, the associated attribute name value within the at least one externally linked file thereby maintaining a reference between the at least one externally linked file and the source code.

16. The method according to claim 15, further comprising
replacing, by the processor, a URL identifying the at least one externally linked file with a modified URL including a token, the token enables the server to decrypt the externally linked file prior to providing content associated with the at least one externally linked file to the requesting user.

17. The method according to claim 13, further comprising
automatically replacing each instance of the associated attribute name value in the source code with a corresponding encrypted attribute name value.

18. The method according to claim 13, further comprising
preventing unauthorized extraction of content by a automated computer program using the encryption of the associated attribute name values by the processor.

19. The method according to claim 13, further comprising
using an encryption key and salt value to encrypt the attribute name values.

20. The method according to claim 19, further comprising
periodically changing an encryption key and salt value used to encrypt the associated attribute name value; and
automatically re-encrypting the associated attribute name value using the changed encryption key and salt value.

21. The method according to claim 13, further comprising
selectively scanning source code of the at least one web page by a scanning processor; and
automatically generating a set of attributes and associated attribute name values derived from the scanned source code for inclusion a configuration file.

22. The method according to claim 21, further comprising
automatically generating, by the scanning processor, the configuration file including the set of attributes and associated attribute name values determined in the scan of the source code.

23. The method according to claim 13, further comprising
periodically analyzing an activity log of the server by the processor to detect whether an occurrence of an activity associated with unauthorized extraction of content was attempted; and
re-encrypting the associated attribute name value in response to detecting the occurrence.

24. The method according to claim 13, further comprising
selectively inserting data in a section of source code of the at least one web page thereby obfuscating the source code and preventing unauthorized extraction of content associated with the at least one web page.
